(19) United States
(12) Patent Application Publication
(10) Pub. No.: US 2011/0302153 A1
(43) Pub. Date: Dec. 8, 2011

(54) Service for Aggregating Event Information

(75) Inventors: Dimitris Meretakis, Zurich (CH); David A. Hotchkiss, Zurich (CH)

(73) Assignee: GOOGLE INC., Mountain View, CA (US)

(21) Appl. No.: 13/153,338

(22) Filed: Jun. 3, 2011

Related U.S. Application Data
(60) Provisional application No. 61/351,801, filed on Jun. 4, 2010.

(51) Int. Cl. G06F 17/30

(52) U.S. Cl. 707/722; 707/E17.014

(57) ABSTRACT

Methods, systems, and apparatus, including computer programs encoded on a computer storage medium, for aggregating event information. In one aspect, a method includes selecting an event from plurality of events based on a query, in which the event is associated with a time frame and one or more event attributes. A document is generated for the event by including a plurality of web resources based on the time frame and one or more of the event attributes, and including a plurality of social network resources that have a semantic similarity to the event.

### CLAIM OF PRIORITY

This application claims priority under 35 USC §119(e) to U.S. Patent Application Ser. No. 61/351,801, filed on Jun. 4, 2010, the entire contents of which are hereby incorporated by reference.

### BACKGROUND

Internet search engines provide information about Internet accessible resources (e.g., web pages and other types of documents, images, audio content, blog posts, social network users posts, text documents, multimedia content) that are responsive to a user's search query by returning a set of search results in response to the query. A search result includes, for example, a Uniform Resource Locator (URL) for the resource and a snippet of information. The search results can be ranked according to scores assigned to them by a scoring function. The scoring function scores the search results according to various signals, for example, where (and how often) query terms appear in the search results and how common the query terms are in the search results indexed by the search engine.

### SUMMARY

This specification relates to digital data processing, and more particularly to techniques for aggregating event information. In general, one innovative aspect of the subject matter described in this specification can be embodied in methods that include the actions of receiving a query; selecting an event from plurality of events based on the query, in which the event is associated with a time frame during which the event takes place and one or more event attributes; generating a document for the event by: identifying a plurality of web resources based on the time frame and one or more of the event attributes; identifying a plurality of social network resources that have a semantic similarity to the event that satisfies a threshold; including one or more of the web resources and one or more of the social network resources in the document; and organizing the presentation of the document based on a display area for a client device. Other embodiments of this aspect include corresponding systems, apparatus, and computer programs, configured to perform the actions of the methods, encoded on computer storage devices.

These and other embodiments can each optionally include one or more of the following features. The query can be a request for the document. The query can comprise one or more terms and selecting the event can further comprise selecting an event from plurality of events based on one or more terms in the query. A term in the one or more terms identifies: the event, a participant for the event, a location for the event, a time frame for the event, a type of the event, or a topic of the event. The generated document can be sent to the client device. Identifying social network resources that have a semantic similarity to the event that satisfies the threshold can further comprise using latent semantic analysis to determine a respective similarity between the event and each of the social network resources. Identifying social network resources that have a semantic similarity to the event that satisfies the threshold can further comprise ignoring social network resources that are associated with respective locations that are not a location for the event. The document can be generated before the query is received. The web resources can include news articles and in which the social network resources include users posts.

Particular embodiments of the subject matter described in this specification can be implemented so as to realize one or more of the following advantages. A service provides an integrated view for individual events (e.g., sports games, concerts, and so on) as well as sequences of events (e.g., tournaments) by aggregating in one place different types of information including factual information, links to news, blogs and web pages, and social network content. In addition to the above, users want to frequently interact with each other around an event: comment, suggest, discuss, contribute content, vote for the quality, and recommend to others. This invention provides this aggregated view of all information for an event and allows the user interaction around the event. This service can be an individual destination or a feature integrated within web search results.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example integrated event view.

FIG. 1B shows an example link on a search engine home page.

FIG. 1C shows a search engine results page.

FIG. 2A presents an overview of an example event information aggregator system.

FIG. 2B illustrates an example event information aggregator system for creating integrated event views.

FIG. 3 is a flow chart of an example technique for providing an integrated event view.

Like reference numbers and designations in the various drawings indicate like elements.

### DETAILED DESCRIPTION

In various implementations, a service is described which provides an integrated view of information pertaining to an event. An event is something that will happen, is happening, or has happened, such as, for instance, a sporting event, a tournament, a conference, a meeting, a concert, a television or movie broadcast, and so on. Events can be tied to a physical location (e.g., a concert hall, a stadium, a city, a geographic landmark). The integrated view can include one or more of the following: factual information pertaining to the event (e.g., scores and standings), news search results about the event, and/or user generated content from social networks. In some implementations, the integrated event view is a document resource such as, for example, a web page. However, other types of integrated event views are possible.

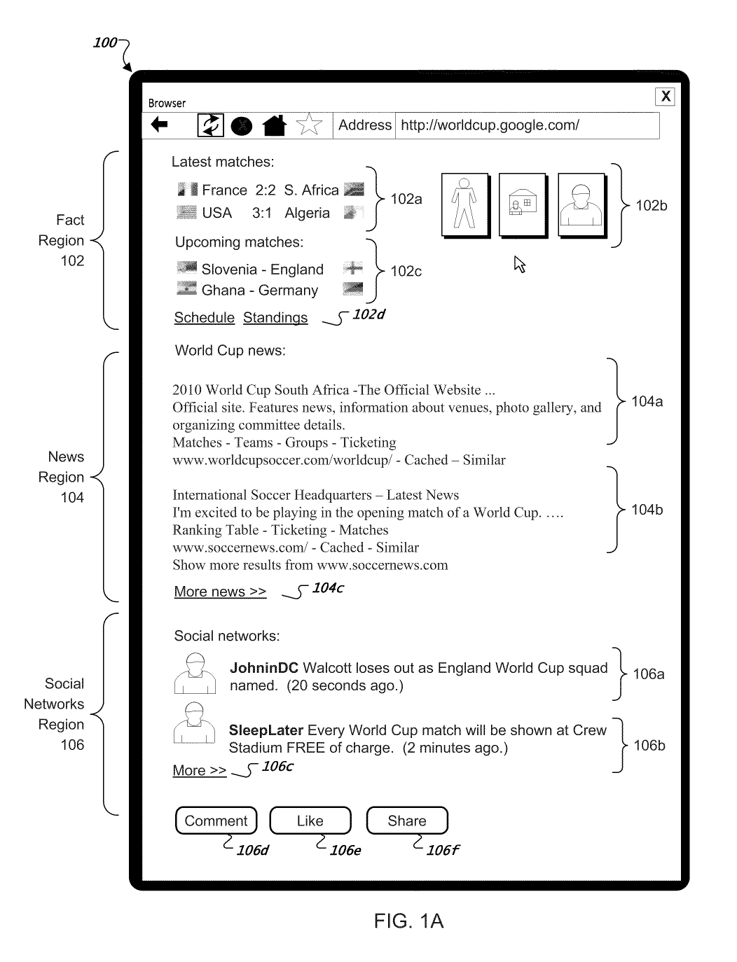

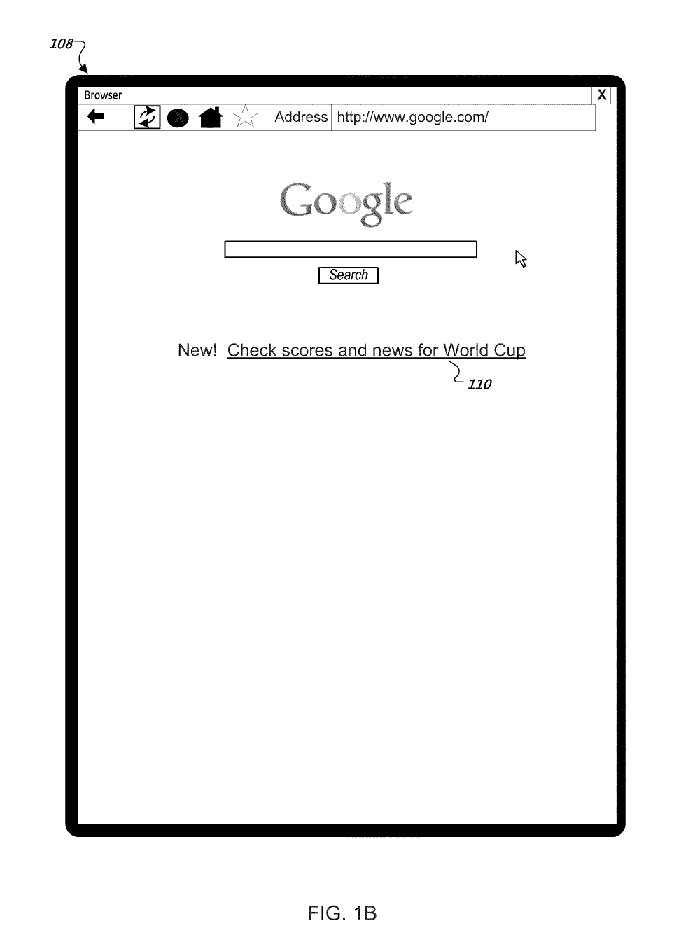

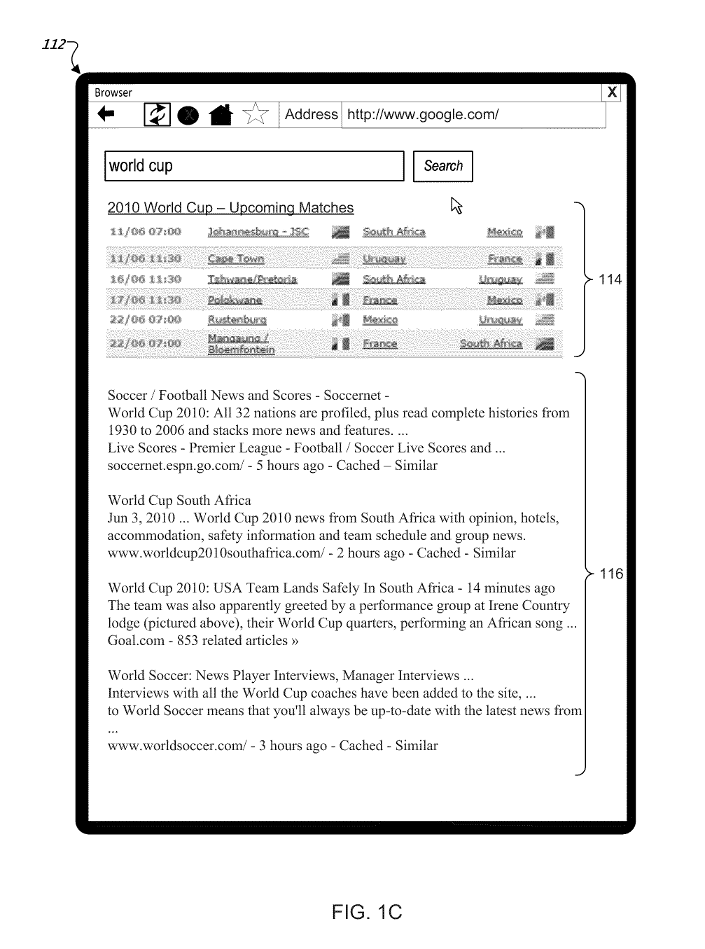

FIG. 1A shows an example integrated event view 100 as presented by a web browser or other software application executing on a client device. The integrated event view 100 in this example is for the 2010 World Cup event and includes a factual information region 102, a news results region 104, and a social networks region 106. Other view regions are possible. Moreover, the regions can be presented in different orders depending on factors such as the type of client device and user preferences. In various implementations, the size of each region and the amount of content shown in each region vary depending on the available display size and display resolution of the client device. A client device is a data processing apparatus such as a personal computer, a smart phone, a tablet computer, or other kind of device having a display. Generally speaking, integrated event view regions presented on client devices having smaller displays will show less content and perhaps have fewer view regions than integrated event views presented on client devices having larger displays.

In some implementations, one or more of the integrated event view 100 regions can be refreshed automatically as new event information becomes available. If the integrated event view 100 is a web page, for example, then asynchronous JAVASCRIPT can be included in the web page which, when executed by a web browser, will asynchronously send requests to a server to obtain updates to the information over time.

Factual information for an event can be obtained from one or more third party provider data feeds, can be constructed algorithmically based on text mining techniques applied to web pages or other resources that contain information about the event, or can be created from combinations of these approaches. In this example, the factual information region 102 includes scores for the most recent World Cup matches 102a, a selection of images 102b from news articles concerning these matches, and a list of upcoming matches 102c. In addition, the factual information region 102 includes several links 102d which can be selected by users to navigate to more detailed information regarding the World Cup such as the overall match schedule and the current standings. The amount of factual information shown in area 102 can depend on the type of event and amount of display area that is available on the client device.

News for an event can be obtained from one or more third party provider data feeds, search engines that return search results referring to articles on newspaper and blog web pages, or combinations of these. News articles related to an event can be obtained with a search engine query using, for example, the event name, names of parties to the event (e.g., team names), and the time frame of the event (e.g., just after the event if it already took place or from the last couple of days if the event is upcoming).

In this example, the news region 104 includes snippets and links to two news articles (104a and 104b), as well as a link 104c which can be selected by users to navigate to more news articles. The news can be ordered according to its date of publication, relevance to the event, or combinations of these. In addition to news articles, other types of content that are relevant to the event can be presented in region 104 including, but not limited to, images, video, maps and shopping results. To obtain images, videos, or shopping results, the search query described above can further be restricted to require the specific result type, for instance. In some implementations, a navigation bar can be provided in the view 100 to allow users to filter the types of results they wish to view in region 104. The amount of information shown in area 104 can depend on the type of event and amount of display area that is available on the client device.

Content from social networks (e.g., Buzz, Twitter and blog posts) populates region 106 of the integrated event view 100. Content from social networks can be obtained from one or more third party provider data feeds, search engines that return search results referring to content on social networks, or combinations of these. Social network content related to an event can be obtained with a search engine query using, for example, the event name, names of parties to the event (e.g., team names), and the timeframe of the event. In some implementations, content from social networks is ordered according to the time it was posted with the most recent posts coming first in the region 106. In further implementations, content from social networks is ordered according to semantic similarity to the event. (Semantic similarity of social network content is discussed further below.) Users can select buttons to add their own comments to the posts through a social network of their choosing by selecting comment button 106d. Users can indicate whether they like or dislike a post by selecting it (e.g., 106a), and then selecting the Like button 106e which will present them with the ability to rate the selected post. Users can share a selected post by selecting the Share button 106f which will allow them to enter email addresses or account names for recipients to whom they wish to send the selected post. In further implementations, users are allowed to log into an integrated event view. Doing so automatically logs users into their social networks and alleviates the need for users to log in to these networks when posting comments or rating posts. The amount of information shown in area 106 can depend on the type of event and amount of display area that is available on the client device.

In further implementations, a location region can be provided in the integrated event view which provides information collected about the location where the event takes place (if applicable). For example, the location information can include a map indicating the location of the event, the location of nearby amenities, cycling paths, the location of social network activities such as Buzz and Twitter posts, the location where images or videos have been captured and are available for viewing, and so on. Users can select the map locations to view detailed information concerning the corresponding event, amenity, social network user post, image, and so on. In the case of an amenity such as a hotel, additional information can include the contact information, room rates, and reviews for the hotel, for example. For images and videos, selecting the corresponding map locations will cause the image or video to be presented. In further implementations, an additional area of the location region can be reserved for listing the detailed information corresponding to items on the map.

The integrated event view (e.g., 100) can be reached in a number of ways. In some implementations, a link (e.g., a hyperlink) is provided to the view 100 on an internet search engine home page. FIG. 1B shows an example link 110 on a search engine home page 108 as presented by a web browser or other software application executing on a client device. In other implementations, a link to the integrated event view can be provided as a search result. For example, FIG. 1C shows a search engine results page 112 as presented by a web browser or other software application executing on a client device. The search query is “world cup.”The search results include a summary of current upcoming matches 114 and regular Internet search results 116. User selection of the region 114 will cause presentation of the integrated event view. In further implementations, users can navigate to an integrated event view by selecting a location on an interactive map (or zooming in on a location) that corresponds to the location of the event. In yet a further implementation, software on a user's client device can cause the client device's web browser to present an integrated event view when the user's client device is within a proximity of the event's location. Other ways of reaching the integrated event view are possible.

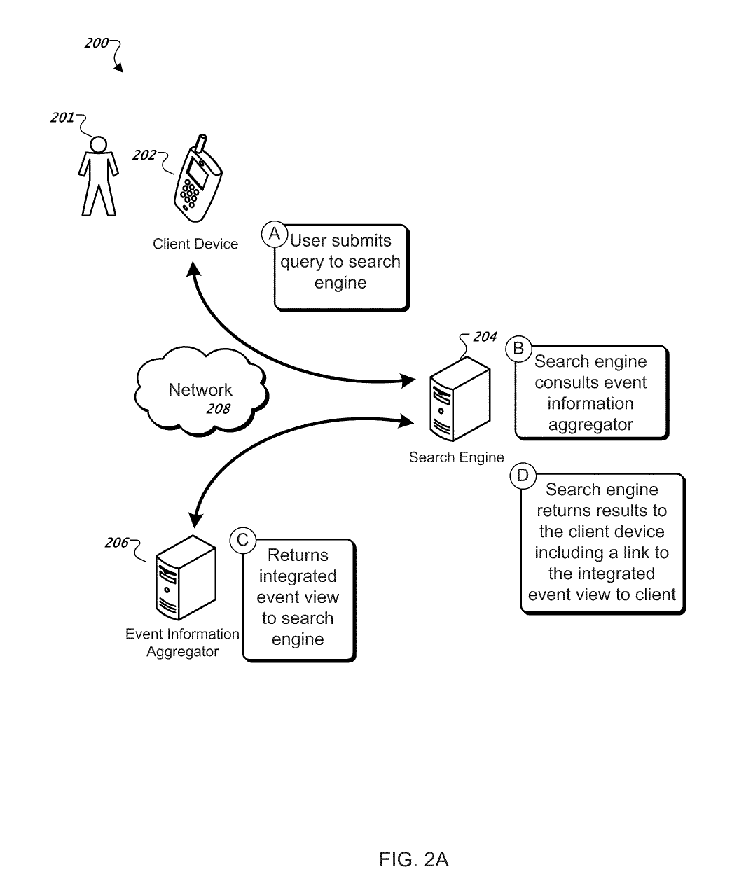

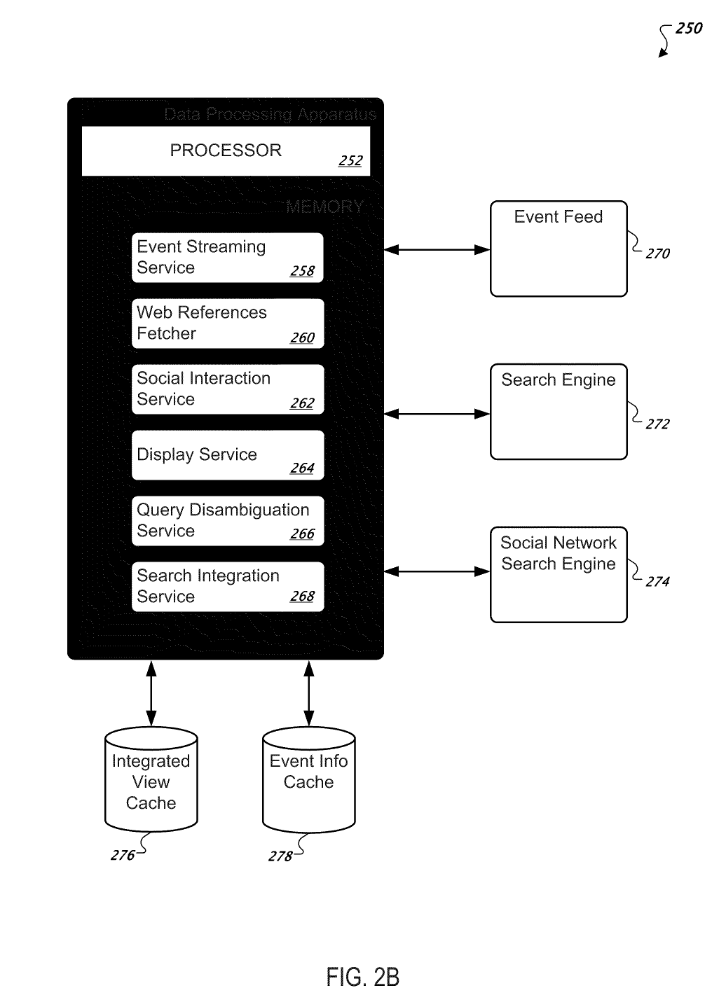

FIG. 2A presents an overview of an example event information aggregator system 200. The system 200 includes one or more client devices (e.g., client device 202), one or more search engines (e.g., search engine 204), and one or more event information aggregators (e.g., event information aggregator 206). The client device 202, search engine 204 and event information aggregator 206 are able to communicate information with each other through one or more networks (e.g., network 208, the Internet).

A user 201 interacts with the system 200 through the client device 202 or other device. For example, the client device 202 can be a personal computer within a local area network (LAN) or wide area network (WAN), or a mobile device such as a smart phone or a tablet computer connected to one or more wireless networks. The client device 202 generally includes a random access memory (RAM) (or other memory and/or a storage device) and a processor. The processor is a single or multi-threaded microprocessor having one or more processor cores, for example. The processor is structured to process instructions stored in the client device's RAM or in other memory and/or a storage device included with the client device. For example, the instructions can implement a web browser or other software application. The client device 202 also includes a display and can include one or more other input/output devices such as a keypad, a microphone, a camera, a touch-sensitive surface, a speaker, an accelerometer, and so on.

The user 201 submits a query to the search engine 204 by way of a web browser or other user interface on the client device 202. A query can comprise text, audio content (e.g., spoken text captured by a microphone), an image (e.g., a snapshot of a business location or QR code captured by a camera), a hand or finger gesture on a touch-sensitive surface, the motion of the client device 202, or combinations of these. The search engine can be realized as a data processing apparatus. Generally speaking, the search engine 204 utilizes one or more indexes which reference a collection of resources and which are used to identify resources that are responsive to queries. Internet search engine indexes index web pages on the world wide web, for example. The search engine 204 can use one or more scoring algorithms to score resources that are retrieved using the indexes. Scores can be used to rank retrieved resources and create a set of search results that are returned in response to queries.

In response to receiving the query, the search engine 204 retrieves search results for the query and also submits the query to the event information aggregator 206. The event information aggregator 206 determines an event that is referenced by the query based on one or more terms in the query and the current date and/or time (if no date or time is specified in the query). For example, if the current date is May 2, 2010, and the query is “world soccer,” a matching event could be the upcoming 2010 World Cup. If a matching event is found, an integrated event view is generated by the event information aggregator 206 and provided to the search engine 204. The search engine 204 can include a link to the integrated event view in search results that it returns to the client device 202.

FIG. 2B illustrates an example event information aggregator system 250 for creating integrated event views as can be implemented in an Internet, intranet, or other client/server environment. The system 250 includes one or more data processing apparatus (e.g., 251), one or more search engines (e.g., 272, 274), and one or more event feed services (e.g., 270). The data processing apparatus 251, search engines 272 and 274, and event feed service 270 communicate through one or more computer or data communication networks.

Software for implementing the event information aggregator 206 executes on the data processing apparatus 251 or on more than one data processing apparatuses 251 which can reside in different locations. A data processing apparatus 251 includes a memory device 254, which can include instructions that implement the event information integration system. A processor 252 is structured to process instructions within the data processing apparatus 251. These instructions can implement one or more components of the event information aggregator 206. The processor 252 can be a single or multi-threaded processor and can include multiple processing cores. The processor 252 can process instructions stored in the memory 254 and communicate with other devices, through one or more networks, to obtain event information and to create integrated event views.

In some implementations, the event information aggregator 206 comprises the following logical components: an event streaming service 258, a web references fetcher 260, a social interaction service 262, a display service 264, a query disambiguation service 266, and a search integration service 268. The functionality of these components can be combined into fewer components or divided into more components. Moreover, the components need not all reside on the same data processing apparatus 251.

In some implementations, the event streaming service 258 collects attribute information regarding events from one or more third party event feeds (e.g., event feed 270). Alternatively, or in addition to, the event streaming service 258 can algorithmically construct attribute information regarding events based on text mining techniques applied to resources available on the web. Generally speaking, text mining or data mining is a process of deriving relevant information from text by identifying patterns through statistical pattern learning. The collected attribute information will vary based on the type of event. The collected attribute information can be stored by the event streaming service 258 in an event information cache 278. In some implementations, newer information concerning an event replaces older information for the same event in the cache 278. Event attribute information can form the content of the fact region 102 of an integrated event view.

By way of illustration, the attribute information for a rock concert (e.g., date, venue, band name, list of previous venues and dates for the band, list of upcoming venues and dates for the band) would be different from that of a sporting event (e.g., date, venue, teams, team lineups, a chronological list of prior game results and scorers, a chronological list of upcoming games, and links to more detailed information such as standings and schedule). The attribute information for events includes, at a minimum, the name of the event and the time frame for when the event will occur. Other attribute information depends on the type of event but can include the information in TABLE 1 below.

TABLE 1

| EVENT | |
|---|---|
| ATTRIBUTE | DESCRIPTION |
| Event name | The name of the event, optionally including one or |
| | more synonyms or alternate names for the event. |
| | Alternatively, synonyms can be determined based |
| | on observing query refinements or other data. |
| Description | A general description of the event. |
| Event time frame | The day(s) and/or time(s) of the event. |
| Location(s) | The location specifies which venue(s) the event will |
| | take place. |
| Participant(s) | Participants to the event such as sports teams, |
| | performers, club members, and so on. |
| Related event(s) | The names of events that are related to this one. |
| Link(s) to more | Links (e.g., URLs) to resources that have additional |
| information | information on the event including a description |
| | of the type of information. |

The web references fetcher 260 collects information from various resources for events received from the event stream service 258. The search results for an event, or a portion thereof, are presented in the news region 104 of an integrated event view. In some implementations, the web references fetcher formulates one or more search queries from an event's attribute information and submits these queries to one or more search engines such as web search engine 272 or to other services that are capable of searching resources. In some implementations, formulated search queries include the name and time frame of the event. By way of illustration, if the event is the 2010 World Cup, formulated search queries could look like “2010 world cup news,” “2010 world cup image,” “2010 world cup video,” or “2010 world cup shopping.” Formulated queries can be even more specific if the location and participants are known: “Rolling Stones, May 8, 2010, Hollywood Bowl.”

In response to a search query from the web references fetcher 260, the web search engine 272 (or other service) returns a list of relevant results to the web references fetcher 260 ordered by their respective ranks The web references fetcher 260 can store top ranked results for an event in the event information cache 278, for example. If the top ranked search results do not appear to be that relevant to the event based on a lack of event attributes found in search result snippets, for example, the web references fetcher 260 can reformulate the query to include more event attributes and then resubmit the query to the search engine 272. The web references fetcher 260 can collect information at various times for a given event and replace older information in the event information cache 278 with newer information (e.g., search results that refer to documents that have more recent creation or update dates).

The social interaction service 262 allows users to interact with other users around an event. The social interaction service 262 maintains lists of recent, relevant user posts pertaining to a given event obtained from various social networks (e.g., Buzz and Twitter) in the event information cache 278. The user posts, or a portion thereof, are presented in the social networks region 106 of an integrated event view. In some implementations, the social interaction service 262 queries one or more social network search engines 274 using queries formulated as above in regards to the web references fetcher 260, for example, in order to obtain recent user posts from the social network search engines 274. Because the content of such posts may contain a term from the formulated query, but otherwise may not be very relevant to an event due to their brevity, the social interaction service 262 in some implementations filters the user posts returned by the social network search engines 274 by determining the semantic similarity between a given post and attribute information for an event.

In some implementations, semantic similarity describes how related or similar the meaning of two texts are. For example, how similar in meaning are an event's attributes to a social network post? Semantic similarity can be determined by a number of techniques including, but not limited to, Latent Semantic Analysis (LSA), Pointwise Mutual Information (PMI), Generalized Latent Semantic Analysis (GLSA), and Incremental Construction of an Associative Network (ICAN), for instance. In some implementations, LSA can be used to determine the similarity between an event's description attribute and a social network post content. Posts that are considered not similar enough to an event's description are not stored in the event information cache 278 (e.g., less than 60% probability that they are similar). The social interaction service 262 can collect information at various times for a given event and replace older information in the event information cache 278 with newer information.

In further implementations, before determining the semantic similarity between a given post and attribute information for an event, the location of the post (e.g., as determined by the global position system or other system) is examined to determine if the location is the same as the event's location or within a defined distance from the event. For example, an initial filter can be applied to social network posts to filter out those which are not located at the event location or are not within a certain distance (e.g., ¼ mile) from the event location. Then, a semantic similarity technique such as LSA can be used to determine if the content of the posts are related to the event.

A display service 264 generates and provides integrated event views as requested by the search integration service 268 (described below). The display service 264 gathers information collected in the event information cache 278 for a given event and formats the information appropriately for the display characteristics of a client device. In some implementations, the display service 264 can cache previously generated integrated event views in cache 276 in order to avoid having to generate an integrated event view more than once for a particular event and client device combination. The display service 264 can include display size and resolution information for a number of different types of client devices. The type of client device can be identified in a hypertext transfer protocol (HTTP) request to a search engine 204, for example. The search engine 204 can pass on the client device type to the event information aggregator 206 as part of its request for an integrated event view which, in turn, can be used by the display service 264 to correctly format the integrated event view.

The search integration service 268 receives user search queries from the search engine 204 and determines if there are matching events for the queries. If a matching event is found for a user query, the search integration service 268 obtains the integrated event view from the display service 264 and returns a link to the view, and optionally a snippet of text describing the event, to the search engine 204. In order to match a search query to an event name, a query disambiguation service 266 is used to modify the user query so that a match is more likely. Initially the query disambiguation service 266 determines if any of the search query's terms match the name attribute of an event or a synonym of the event's name attribute. These events are called “matching events.” If there is only one matching event, then the query disambiguation service 266 provides the name of the event to the search integration service 268. If there is more than one matching event, the query disambiguation service 266 next determines which of the matching events have attribute values that are closest to those found in the search query's terms. In some implementations, a matching event can be chosen based on its click through rate (when it is presented as a search result), its content quality, the number of matching attributes to the query, or combinations of these. Other ways of selecting a matching event are possible.

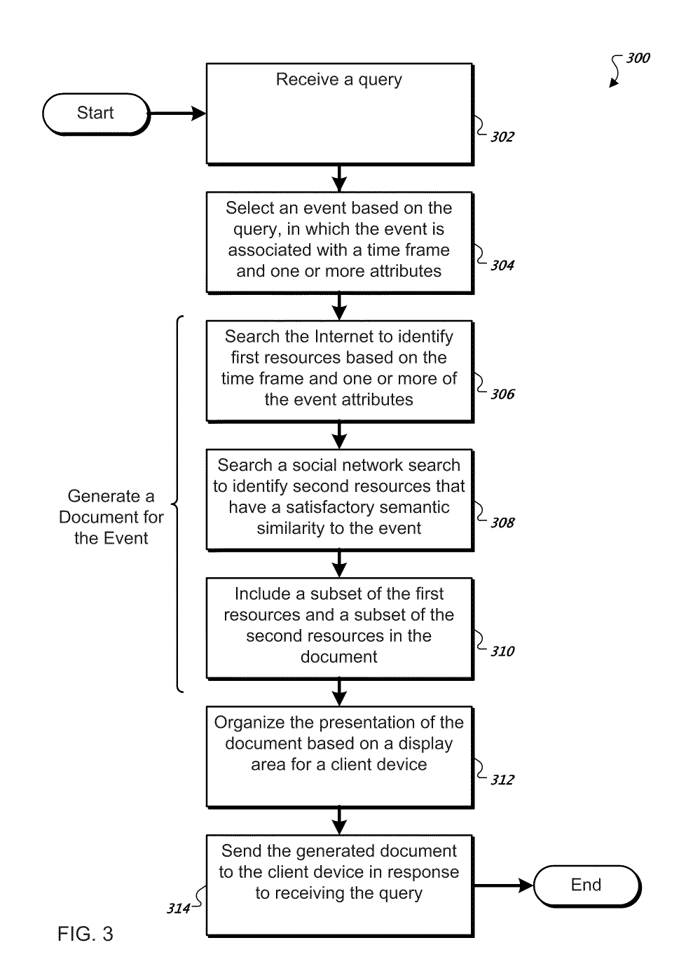

FIG. 3 is a flow chart of an example technique for providing an integrated event view 300. A query is received, e.g., by the event information aggregator (block 302). For example, the query can be received from a client device 202 or a search engine 204. An event is then selected by the search integration service 268, for example, from plurality of events based on the query, in which the event is associated with a time frame and one or more event attributes (block 304). Next, an integrated event view is generated for the selected event (if it has not already been generated). The Internet is searched, e.g., by the web references fetcher 260, to identify resources based on the selected event's time frame and one or more of the event's attributes (block 306). A social network is searched, e.g., by the social interaction service 262, to identify resources that have a semantic similarity to the event that satisfies a threshold (block 308). A subset of both sets of resources is included in the integrated event view document (block 310; e.g., by the display service 264), and the document is organized according to the display area of a client device (block 312; e.g., by the display service 264). Finally, the generated document is sent to the client device in response to the query (block 314).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a query;
selecting an event from plurality of events based on the query, in which the event is associated with a time frame during which the event takes place and one or more event attributes;
generating a document for the event by:
identifying a plurality of web resources based on the time frame and one or more of the event attributes;
identifying a plurality of social network resources that have a semantic similarity to the event that satisfies a threshold;
including one or more of the web resources and one or more of the social network resources in the document; and
organizing the presentation of the document based on a display area for a client device.

2. The method of claim 1 in which the query is a request for the document.

3. The method of claim 1 in which the query comprises one or more terms and in which selecting the event further comprises selecting an event from plurality of events based on one or more terms in the query.

4. The method of claim 3 in which a term in the one or more terms identifies: the event, a participant for the event, a location for the event, a time frame for the event, a type of the event, or a topic of the event.

5. The method of claim 1 further comprising sending the generated document to the client device.

6. The method of claim 1 in which identifying social network resources that have a semantic similarity to the event that satisfies the threshold further comprises using latent semantic analysis to determine a respective similarity between the event and each of the social network resources.

7. The method of claim 1 in which identifying social network resources that have a semantic similarity to the event that satisfies the threshold further comprises ignoring social network resources that are associated with respective locations that are not a location for the event.

8. The method of claim 1 in which the document is generated before the query is received.

9. The method of claim 1 in which the web resources include news articles and in which the social network resources include users posts.

10. A computer program product encoded on a machine-readable medium, the program product including instructions operable to cause a data processing apparatus to perform operations comprising:
receiving a query;
selecting an event from plurality of events based on the query, in which the event is associated with a time frame during which the event takes place and one or more event attributes;
generating a document for the event by:
identifying a plurality of web resources based on the time frame and one or more of the event attributes;
identifying a plurality of social network resources that have a semantic similarity to the event that satisfies a threshold;
including one or more of the web resources and one or more of the social network resources in the document; and
organizing the presentation of the document based on a display area for a client device.

11. The program product of claim 10 in which the query is a request for the document.

12. The program product of claim 10 in which the query comprises one or more terms and in which selecting the event further comprises selecting an event from plurality of events based on one or more terms in the query.

13. The program product of claim 12 in which a term in the one or more terms identifies: the event, a participant for the event, a location for the event, a time frame for the event, a type of the event, or a topic of the event.

14. The program product of claim 10 including further instructions operable to cause the data processing apparatus to perform further operations comprising sending the generated document to the client device.

15. The program product of claim 10 in which identifying social network resources that have a semantic similarity to the event that satisfies the threshold further comprises using latent semantic analysis to determine a respective similarity between the event and each of the social network resources.

16. The program product of claim 10 in which identifying social network resources that have a semantic similarity to the event that satisfies the threshold further comprises omitting social network resources that are associated with respective locations that are not a location for the event.

17. The program product of claim 10 in which the document is generated before the query is received.

18. The program product of claim 10 in which the web resources include news articles and in which the social network resources include users posts.

19. A system comprising:
one or more data processing apparatus configured to perform operations comprising:
receiving a query;
selecting an event from plurality of events based on the query, in which the event is associated with a time frame during which the event takes place and one or more event attributes;
generating a document for the event by:
identifying a plurality of web resources based on the time frame and one or more of the event attributes;
identifying a plurality of social network resources that have a semantic similarity to the event that satisfies a threshold;
including one or more of the web resources and one or more of the social network resources in the document; and
organizing the presentation of the document based on a display area for a client device.

20. The system of claim 19 in which the query is a request for the document.

21. The system of claim 19 in which the query comprises one or more terms and in which selecting the event further comprises selecting an event from plurality of events based on one or more terms in the query.

22. The system of claim 21 in which a term in the one or more terms identifies: the event, a participant for the event, a location for the event, a time frame for the event, a type of the event, or a topic of the event.

23. The system of claim 19 including further instructions operable to cause the data processing apparatus to perform further operations comprising sending the generated document to the client device.

24. The system of claim 19 in which identifying social network resources that have a semantic similarity to the event that satisfies the threshold further comprises using latent semantic analysis to determine a respective similarity between the event and each of the social network resources.

25. The system of claim 19 in which identifying social network resources that have a semantic similarity to the event that satisfies the threshold further comprises omitting social network resources that are associated with respective locations that are not a location for the event.

26. The system of claim 19 in which the document is generated before the query is received.

27. The system of claim 19 in which the web resources include news articles and in which the social network resources include users posts.
